(19) United States
(12) Patent Application Publication
(10) Pub. No.: US 2014/0253559 A1
(43) Pub. Date: Sep. 11, 2014

(54) UI AUTOMATION BASED ON RUNTIME IMAGE

(71) Applicant: VMWARE, INC., Palo Alto, CA (US)

(72) Inventors: Yingjun LI, Beijing (CN); Yingji SUN, Beijing (CN); Qingyu ZHAO, Beijing (CN)

(73) Assignee: VMWARE, INC., Palo Alto, CA (US)

(21) Appl. No.: 13/787,801

(22) Filed: Mar. 7, 2013

(51) Int. Cl. G06T 11/60

(52) U.S. Cl. CPC G06T 11/60
USPC 345/467

(57) ABSTRACT

In one example, a method is provided to identify a user interface (UI) element on a UI of a program based on runtime images generated in the same runtime environment as the program. The method includes reading an instruction in a script and executing the instruction. The instruction identifies a text string. Executing the instructions includes generating a runtime image of the text string in the runtime environment and searching for any UI element on the UI that matches the runtime image.

### BACKGROUND

Unless otherwise indicated herein, the approaches described in this section are not prior art to the claims in this application and are not admitted to be prior art by inclusion in this section.

A typical user interface (UI) element is a pictograph, a label, or a combination of a pictograph and a label on or about the pictograph. A “label” here refers to glyphs that graphically represent the characters in a text string, such is the name of the UI element, that is rendered as an image for display on a screen. For example, a UI element to save a file in a word processor may be a combination of a pictograph of a floppy disk and a label of the text string “Save” located to the right of the pictograph.

Sikuli and Xpresser are typical UI automation tools based on image comparison. A scripter first captures images of buttons, menus, input fields, and other UI elements from screenshots of a software program. The scripter writes an automation script based on the captured images to interact with the program (e.g., to test the program). Executing the automation script, an automation tool attempts to find the captured images on the screen and operate them, such as clicking on them, when these images are successfully located on the screen. FIG. 5 shows an example of the code in the automation script for clicking a UI element having a matching image.

Some automation tools also include an optical character recognition (OCR) module that attempts to find the UI elements on the screen by recognizing the text strings represented by their labels. For example, if a UI element contains an image that represents a label that says “SnapShot2”, the OCR module may be used to extract the text “SnapShot2.” FIG. 6 shows an example of the code in the automation script for clicking a UI element having a label of a text string “Snapshot2.”

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are therefore not to be considered limiting of its scope, the disclosure will be described with additional specificity and detail through use of the accompanying drawings.

In the drawings:

FIG. 1 is a block diagram of a system to implement user interface automation based on runtime images in one example of the present disclosure;

FIG. 2 is a flowchart of a method for an automation tool of FIG. 1 to interact with a software program of FIG. 1 in one example of the present disclosure;

FIG. 3 is a flowchart of a method for the automation tool of FIG. 1 to interact with the software program of FIG. 1 in one example of the present disclosure;

FIG. 4 is a block diagram of a computing device for implementing the automation tool and software program of FIG. 1 in one example of the present disclosure;

FIG. 5 shows an example of a code in an automation script for clicking a user interface element; and

FIG. 6 shows an example of a code in an automation script for clicking a user interface element;

FIG. 7 shows examples of functions implemented by the automation tool of FIG. 1 in one example of the present disclosure; and

FIG. 8 shows an example of a code in an automation script for clicking a user interface in one example of the present disclosure.

### DETAILED DESCRIPTION

As used herein, the term “includes” means includes but not limited to, and the term “including” means including but not limited to. The terms “a” and “an” are intended to denote at least one of a particular element. The term “based on” means based at least in part on.

An automation tool based on image comparison has certain disadvantages. A scripter may spend considerable time capturing images of user interface (UI) elements of a software program. An automation script based on the captured images may not work on multiple platforms when the UI elements look different in various operating systems, versions of the same operating system (OS), or desktop environments of the same OS. For example, the scripter may not be able to consistently capture images of the UI elements from an application running on Windows and then use those images to find and operate on the same UI elements in a Linux-based version of the same application, because those UI elements may look different when displayed in these two operating systems. Similarly, the scripter cannot capture images of the UI elements on Gnome and then find and operate them on KDE when the UI elements look different in these two desktop environments of Linux. To accommodate a variety of platforms, the scripter may have to capture images of the UI elements in each platform and write an automation script for each platform based on the captured images of that platform.

Alternatively the scripter may write an automation script that uses optical character recognition (OCR) to find and operate the UI elements based on their labels. However OCR has certain disadvantages as well. OCR may be affected by screen resolution. Some labels may only be recognizable at certain screen resolutions. Different labels may be recognizable at different screen resolutions, which make these labels difficult to predict and fix. OCR may not be able to distinguish between similar labels. The inability of OCR to consistently and accurately extract text labels from images may prevent the automation system from properly operating.

In examples of the present disclosure, an automation tool executing an automation script generates an image of a text string in the same runtime environment as a software program. Runtime environment refers to a rendering subsystem of a computing device that is responsible for constructing the final image, such as hardware, OS, device driver, and their configurations. The “runtime image” matches a label of a UI element on the screen when the runtime image and the label graphically represent the same text string and they are generated with the same text properties. An automation script that employs this technique is not tied to a specific operating system, version of the operating system, or desktop environment of the operating system because the runtime image is dynamically generated in each runtime environment. Once generated, the runtime image may be saved and reused. Thus the automation tool frees the scripter from having to capture images from multiple platforms and writing automation scripts for multiple platforms, and avoids OCR and its disadvantages.

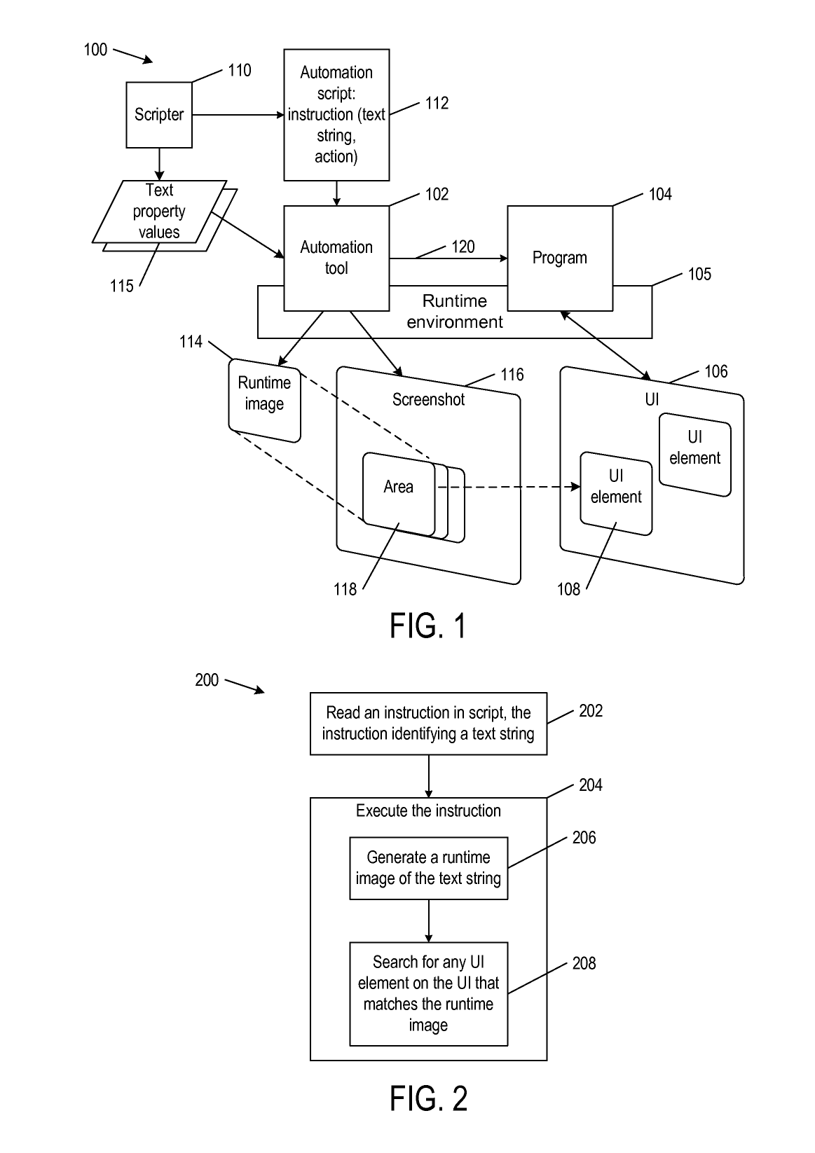

FIG. 1 is a block diagram of a system 100 to implement UI automation based on runtime images in one example of the present disclosure. System 100 includes an automation tool 102 to interact with a software program 104. In one example, automation tool 102 and program 104 operate in the same runtime environment 105. For example, automation tool 102 and program 104 run on the same computing device. Program 104 has a user interface 106 including UI elements. A UI element 108 has a label.

A scripter 110 writes an automation script 112 that defines how automation tool 102 is to interact with program 104. Scripter 110 may write script 112 to test program 104, to remotely control program 104, or to operate program 104 for another purpose.

Automation tool 102 executes instructions in script 104. An instruction in script 104 is a function that identifies a text string and an action. In response to the instruction, automation tool 102 generates a runtime image 114 of the text string. Automation tool 102 renders runtime image 114 with a set of text property values 115. The text properties determine text appearance, such as font type, font size, font style, dots per inch (DPI), anti-aliasing setting, and font hinting setting.

Automation tool 102 captures a screenshot 116 of UI 106 and searches over the screenshot for an area that matches runtime image 114. When a matching area 118 on screenshot 116 is found, automation tool 102 determines a UI element 108 that matches runtime image 114 is located at a corresponding location on UI 106. Automation tool 102 then performs the action in the instruction to the matching UI element 108, where the performance of this action is represented by reference number 120. The action may be single, double, or right clicking UI element 108, hovering over UI element 108, dragging and dropping UI element 108, typing text into UI element 108, pasting text into UI element 108, or manipulating a slider on UI element 108.

When a matching area is not found, automation tool 102 may generate another runtime image with a different set of text property values 115 and repeat the above process. As the values of the text properties are finite, runtime images may be generated with all the possible combinations of text property values. Instead of generating one runtime image at a time, automation tool 102 may generate multiple runtime images 114 at the same time and attempt to find a match in parallel. The text properties that determine text appearance include font type, font style, font size, dots per inch (DPI), anti-aliasing setting, and font hinting setting. The text properties may also include kerning, tracking, underline, and strikethrough.

In one example, scripter 110 determines the system font type, font style, and font size from the OS in runtime environment 105 as some software inherit these text properties from the OS. The system font type, font style, and font size may be found in the desktop appearance settings of the OS (e.g., control panel in Windows OS or system preferences in the Mac OS). These system text properties are used by automation tool 102 to generate runtime image 114. Alternatively scripter 110 uses common values of these text properties for UIs found in various runtime environments. Common font types include Tahoma, Segoe UI, Sans Serif, and Ubuntu. Common font sizes range between 10 and 15. Common font styles include regular, bold, and italic.

DPI is a measurement of monitor or printer resolution that defines how many dots are placed when an image is displayed or printed. In one example, scripter 110 determines the system DPI from the OS in runtime environment 105 as some software inherit their DPIs from the OS. The system DPI may be found in the desktop appearance settings of the OS. Alternatively scripter 110 uses common values of this text property for UIs found in various runtime environments. The common DPIs include 72, 96, 120, and 144.

Anti-aliasing is used to blend edge pixels to emulate smooth curves of glyphs and reduce the stair-stepping or jagged appearance. In one example, scripter 110 determines the system anti-aliasing setting from the OS in runtime environment 105 as some software inherit anti-alias settings from the OS. The system anti-alias setting may be found in the desktop appearance settings of the OS. Alternatively scripter 110 uses the common settings of this text property for UIs found in various runtime environments. Table 1 below lists common anti-alias settings and the corresponding anti-alias algorithms.

TABLE 1

| Anti-alias setting | Algorithm description |
|---|---|
| “off” or “false” | Disable font smoothing. |
| “on” | Gnome Best shapes/Best contrast (no equivalent |
| | Windows setting). |
| “gasp” | Windows “Standard” font smoothing (no |
| | equivalent Gnome setting). It means using the |
| | font's built-in hinting instructions only. |
| “lcd” or “lcd_hrgb” | Gnome “sub-pixel smoothing” and Windows |
| | “ClearType”. |
| “lcd_hbgr” | Alternative “lcd” setting. |
| “lcd_vrgb” | Alternative “lcd” setting. |
| “lcd_vbgr” | Alternative “lcd” setting. |

Font hinting is used to modify the outline of glyphs to fit a rasterized grid. Font hinting is typically created in a font editor during the typeface design process and embedded in the font. However some OSs have the capability to set font hinting levels, such as none, slight, medium, and full. In one example, scripter 110 determines the system font hinting setting from the desktop appearance settings of the OS in runtime environment 105. Alternatively scripter 110 uses the common settings of this text property for UIs found in various runtime environments.

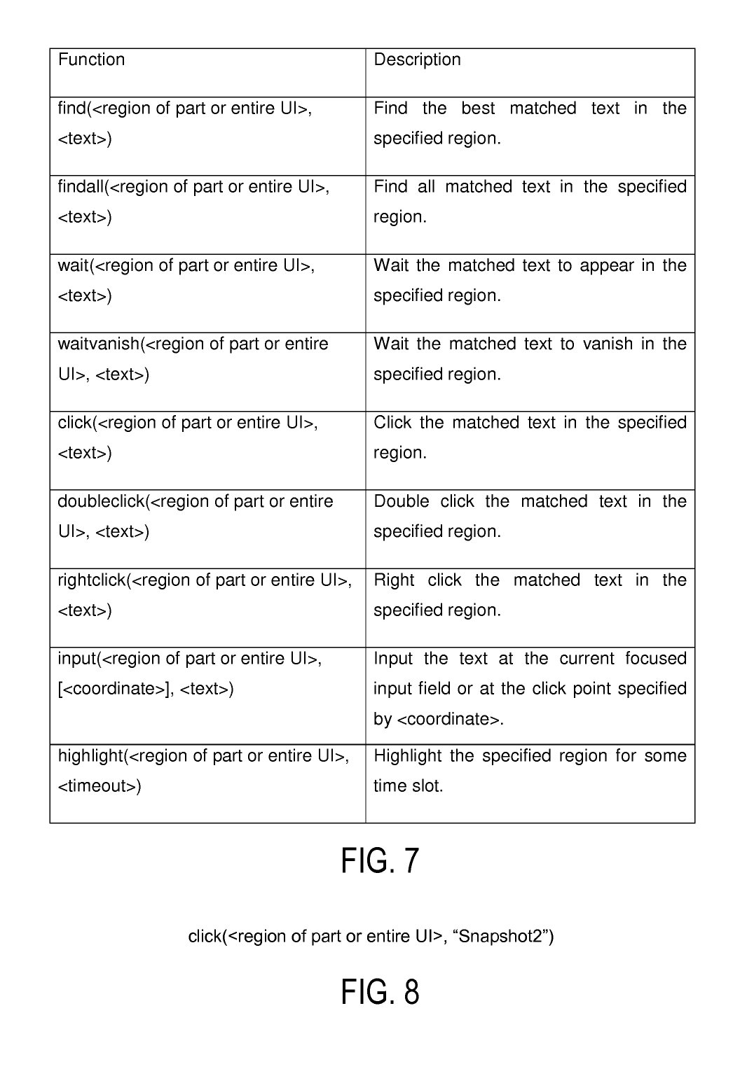

Examples of functions implemented by automation tool 102 are provided in FIG. 7 in one example of the present disclosure.

In another example, automation tool 102 and program 104 operate in different runtime environments. For example, automation tool 102 and program 104 run on different computing devices. To generate runtime image 114 in the local runtime environment of program 104, automation tool 102 remotes into the computing device of program 104. Automation tool 102 may have a client component that generates runtime image 114 in the computing device of program 104.

FIG. 2 is a flowchart of a method 200 for automation tool 102 (FIG. 1) to identify UI elements of program 104 (FIG. 1) and interact with program 104 in one example of the present disclosure. Any method described herein may include one or more operations, functions, or actions illustrated by one or more blocks. Although the blocks are illustrated in sequential orders, these blocks may also be performed in parallel, and/or in a different order than those described herein. Also, the various blocks may be combined into fewer blocks, divided into additional blocks, and/or eliminated based upon the desired implementation. Method 200 may begin in block 202.

In block 202, automation tool 102 reads an instruction in script 112 (FIG. 1). As described above, an instruction includes a text string and an action. Block 202 may be followed by block 204.

In block 204, automation tool 102 executes the instruction. Block 204 may include sub-blocks 206 and 208. In sub-block 206, automation tool 102 generates runtime image 114 (FIG. 1) of the text string in the instruction. Sub-block 206 may be followed by sub-block 208. In sub-block 208, automation tool 102 searches for any UI element on UI 106 (FIG. 1) that matches runtime image 114.

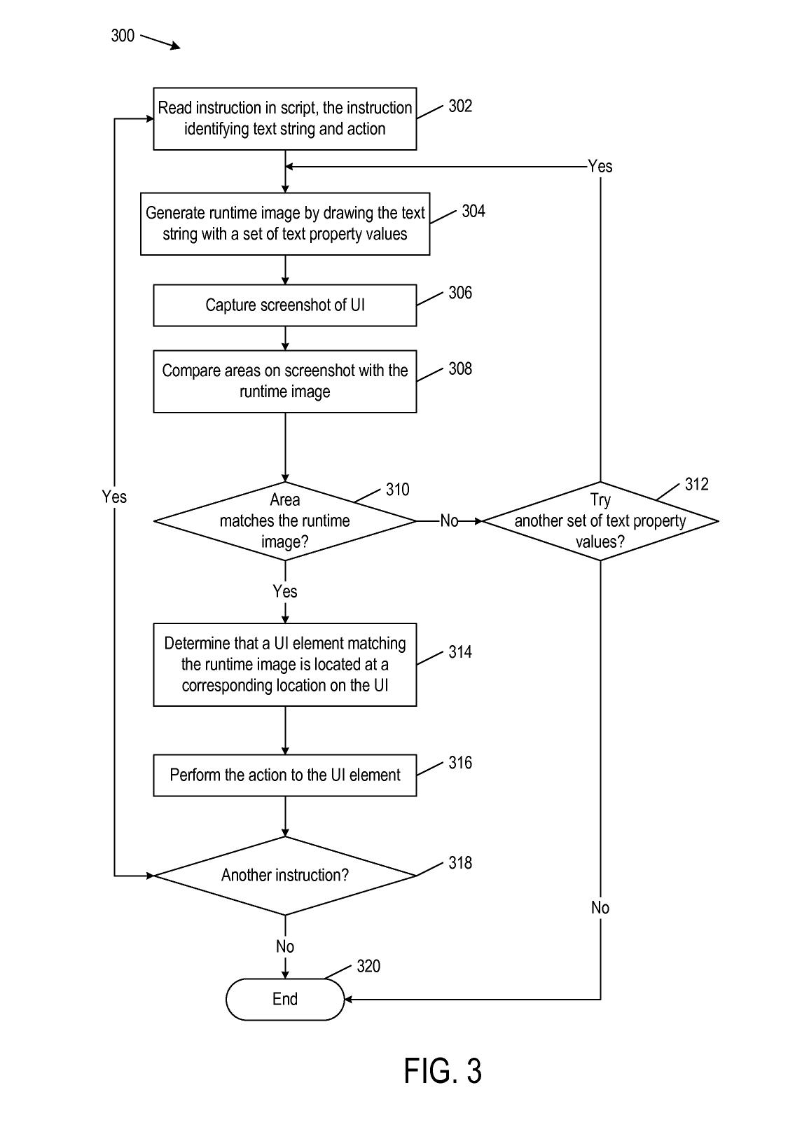

FIG. 3 is a flowchart of a method 300 for automation tool 102 (FIG. 1) to interact with program 104 (FIG. 1) in one example of the present disclosure. Method 300 may be a variation of method 200. Method 300 may begin in block 302.

In block 302, automation tool 102 reads an instruction in script 112 (FIG. 1). As described above, an instruction includes a text string and an action. FIG. 8 shows an example of the instruction in a running example for method 300 in one example of the present disclosure. Note that script 112 may also cause automation tool 102 to launch program 104 if program 104 is not currently running. Block 302 may be followed by block 304.

In block 304, automation tool 102 automatically generates runtime image 114 (FIG. 1) of the text string in the instruction in the runtime environment of program 104 (or causes runtime image 114 to be generated in the local runtime environment of program 104). Automation tool 102 draws runtime image 114 based on text property values 115 (FIG. 1) set by scripter 110. In the running example, automation tool 102 draws a runtime image 114 that graphically represents the text string of “Snapshot2.” Block 304 may be followed by block 306.

In block 306, automation tool 102 captures screenshot 116 (FIG. 1) of UI 106 (FIG. 1). Block 306 may be followed by block 308.

In block 308, automation tool 102 compares areas on screenshot 116 with runtime image 114. Block 308 may be followed by block 310.

In block 310, automation tool 102 determines if an area in screenshot 116, such as area 118 (FIG. 1), matches runtime image 114. If no, block 310 may be followed by block 312. If yes, block 310 may be followed by block 314. An area on screenshot 116 matches runtime image 114 when a similarity score determined by an image comparison algorithm is greater than or equal to a threshold.

In block 312, automation tool 102 determines if it should try another combination of text property values. For example, automation tool 102 may prompt scripter 110 for a decision and another combination of text property values. If yes, block 312 may loop back to block 304 to generate another runtime image. If no, block 312 may be followed by block 320 that ends method 300.

In block 314, when a matching area 118 on screenshot 116 is found, automation tool 102 determines a UI element 108 (FIG. 1) that matches runtime image 114 is located at a corresponding location on UI 106. Block 314 may be followed by block 316.

In block 316, automation tool 102 performs the action in the instruction at the location of UI element 108 on UI 106 where. In the running example, automation tool 102 clicks UI element 108. Block 316 may be followed by block 318.

In block 318, automation tool 102 determines if there is another instruction in script 112 to execute. If yes, block 318 may loop back to block 302 to read another instruction from script 112. If no, block 318 may be followed by block 320 that ends method 300.

As described above, automation tool 102 in method 300 attempts to match one runtime image at a time to areas on a screenshot. Alternatively automation tool 102 may generate multiple runtime images from various combinations of text property values and attempt to match the runtime images to areas on the screenshot in parallel.

In another example, automation tool 102 saves runtime image 114 generated in block 304 in a database along with the text string. When automation tool 102 reads another instruction in script 112 that identifies the same text string, automation tool 102 does not regenerate runtime image 114. Instead, automation tool 102 executes this other instruction by retrieves runtime image 114 from the database based on the text string and then searches for any UI element on UI 106 that matches runtime image 114.

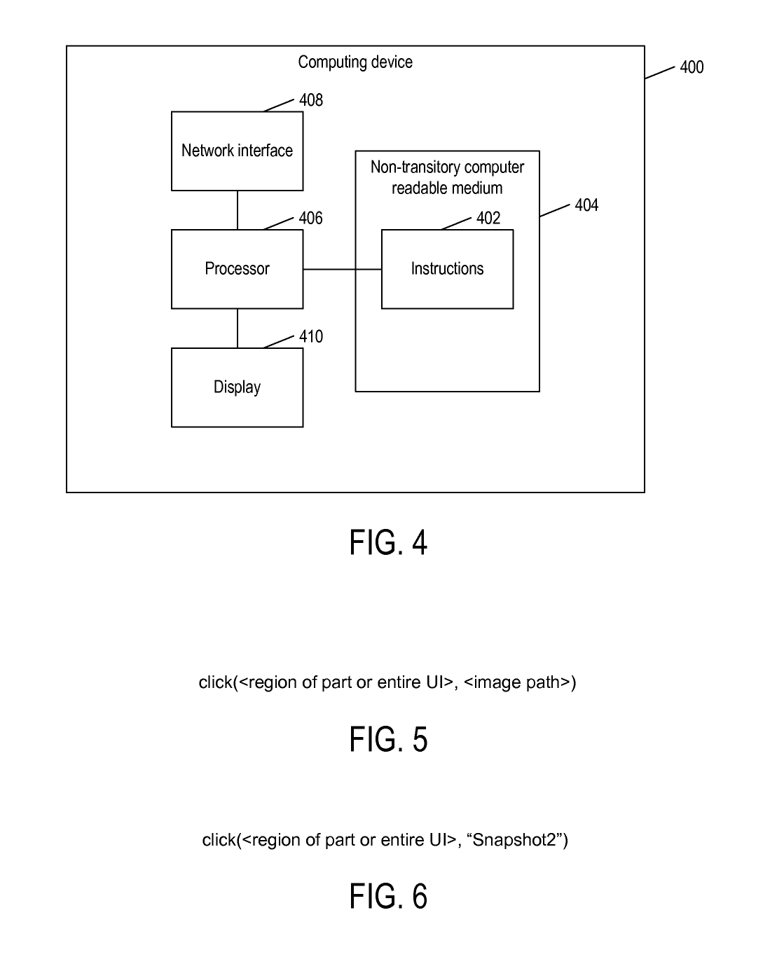

FIG. 4 is a block diagram of a computing device 400 for implementing automation tool 102 and program 104 in one example of the present disclosure. Automation tool 102 and program 104 are implemented with processor executable instructions 402 stored in a non-transitory computer medium 404, such as a hard disk drive, a solid state drive, network attached storage (NAS), read-only memory, random-access memory (e.g., a flash memory device), a CD (Compact Discs) CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion. A processor 406 executes instructions 402 to provide the described features and functionalities, which may be implemented by sending instructions to a network interface 408 or a display 410.

The various embodiments described herein may be practiced with other computer system configurations including hand-held devices, microprocessor systems, microprocessor-based or programmable consumer electronics, minicomputers, mainframe computers, and the like.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A method for an automation tool to identify a user interface (UI) element on a UI of a program based on runtime images generated in a runtime environment of the program, the method comprising:
reading an instruction in a script, the instruction identifying a text string;
executing the instruction, comprising:
generating a runtime image of the text string in the runtime environment; and
searching for any UI element on the UI that matches the runtime image.

2. The method of claim 1, wherein generating a runtime image of the text string in the runtime environment comprises drawing the text string with a set of text property values that determine text appearance.

3. The method of claim 2, wherein executing the instruction further comprises, when no UI element on the UI matches the runtime image:
generating a different runtime image of the text string by drawing the other runtime image with a different set of text property values; and
searching for any UI element on the UI that matches the other runtime image.

4. The method of claim 3, wherein the text property values include a font type, a font style, and a font size.

5. The method of claim 3, wherein the text property values include a dots per inch (DPI), an anti-alias setting, and a font hinting setting.

6. The method of claim 1, wherein:
the instruction further identifies an action; and
executing the instruction further comprises, when the UI element on the UI matches the runtime image, performing the action to the UI element.

7. The method of claim 6, wherein performing the action on the UI element comprises clicking the UI element, hovering over the UI element, dragging and dropping the UI element, typing text, pasting text, or manipulating a slider.

8. The method of claim 1, wherein searching for any UI element on the UI that matches the runtime image comprises:
capturing a screenshot of the UI;
comparing areas on the screenshot with the runtime image; and
when an area on the screenshot matches the runtime image, determining that the UI element that matches the runtime image is located at a corresponding location on the UI.

9. The method of claim 1, further comprising executing the program in a same computing device or a different computing device as the automation tool.

10. The method of claim 1, further comprising:
saving the runtime image;
reading another instruction in a script, the other instruction identifying the text string;
executing the other instruction, comprising:
retrieving the runtime image; and
searching for any UI element on the UI that matches the runtime image.

11. A non-transitory, computer-readable storage medium encoded with instructions executable by a processor to:
read an instruction in a script to identify a user interface (UI) element on a UI of a program, the instruction identifying a text string;
execute the instruction, comprising:
generate a runtime image of the text string in a runtime environment of the program; and
search for any UI element on the UI that matches the runtime image.

12. The non-transitory, computer-readable storage medium of claim 11, wherein generate a runtime image of the text string comprises draw the text string with a set of text properties values that determine text appearance.

13. The non-transitory, computer-readable storage medium of claim 11, wherein execute the instruction further comprises, when no UI element on the UI matches the runtime image:
generate a different runtime image of the text string by drawing the different runtime image with a different set of text properties values; and
search for any UI element on the UI that matches the other runtime image.

14. The non-transitory, computer-readable storage medium of claim 12, wherein the text property values include a font type, a font style, and a font size.

15. The non-transitory, computer-readable storage medium of claim 12, wherein the text property values include a dots per inch (DPI), an anti-alias setting, and a font hinting setting.

16. The non-transitory, computer-readable storage medium of claim 10, wherein:
the instruction further identifies an action; and
execute the instruction further comprises, when the UI element on the UI matches the runtime image, perform the action to the UI element.

17. The non-transitory, computer-readable storage medium of claim 15, wherein perform the action on the UI element comprises click the UI element, hover over the UI element, drag and drop the UI element, type text, paste text, or manipulate a slider.

18. The non-transitory, computer-readable storage medium of claim 10, wherein search for any UI element on the UI that matches the runtime image comprises:
capture a screenshot of the UI;
compare areas on the screenshot with the runtime image; and
when an area on the screenshot matches the runtime image, determine that the UI element that matches the runtime image is located at a corresponding location on the UI.

19. The non-transitory, computer-readable storage medium of claim 10, wherein the instructions executable by the processor include executing the program.

20. The non-transitory, computer-readable storage medium of claim 11, wherein the instructions executable by the processor include:
save the runtime image;
read another instruction in a script, the other instruction identifying the text string;
execute the other instruction, comprising:
retrieve the runtime image; and
search for any UI element on the UI that matches the runtime image.
